(19) United States
(12) Patent Application Publication
(10) Pub. No.: US 2023/0362421 A1
(43) Pub. Date: Nov. 9, 2023

(54) ALIGNING A PLURALITY OF VARIOUSLY ENCODED CONTENT STREAMS

(71) Applicant: Meta Platforms Inc., Menlo Park, CA (US)

(72) Inventor: Jorge CENZANO FERRET, Seattle, WA (US)

(73) Assignee: Meta Platforms Inc., Menlo Park, CA (US)

(21) Appl. No.: 18/314,539

(22) Filed: May 9, 2023

Related U.S. Application Data
(60) Provisional application No. 63/339,790, filed on May 9, 2022.

(51) Int. Cl. H04N 21/242; H04N 21/8547

(52) U.S. Cl. CPC H04N 21/242; H04N 21/8547

(57) ABSTRACT

According to examples, a system for aligning a plurality of variously encoded content streams is described. The system may include a processor and a memory storing instructions. The processor, when executing the instructions, may cause the system to decode content data of a content item, extract signal information from the decoded content data, and process the decoded content data to align with content data from one or more other encodings utilizing the extracted signal information. The processor, when executing the instructions, may then process the decoded content data to be interchangeable with the content data from the one or more other encodings utilizing the extracted signal information and deliver one or more aligned and interchangeable encodings to a content delivery network (CDN).

### PRIORITY

This patent application claims priority to U.S. Provisional Patent Application No. 63/339,790, entitled “Aligning a Plurality of Variously Encoded Content Streams,” filed on May 9, 2022.

### TECHNICAL FIELD

This patent application relates generally to generation and delivery of data, and more specifically, to systems and methods for aligning a plurality of variously encoded content streams.

### BACKGROUND

With recent advances in technology, prevalence and proliferation of content creation and delivery has increased greatly in recent years. Content creators are continuously looking for ways to deliver more appealing content.

One content type often favored by users may be “streaming” content. In some examples, to generate a streaming content item, a plurality of audio and video encodings may be provided. In some instances, the plurality of audio and video encodings may provide redundancy via implementation of a “switch” between a first encoding stream and a second encoding stream. In particular, in some instances, where the first encoding stream may fail, the second encoding stream may be made available.

However, in some instances, implementing a switch may lead to deficiencies in user experience. In particular, in some instances, switching from a first stream to a second stream may result in a temporal “jump” in video playback and/or a “glitch” in audio playback, or in the worst-case scenario, an interruption in playback.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1 illustrates a block diagram of a system environment configured to align a plurality of variously encoded content streams, according to an example.

FIG. 2A illustrates a block diagram of a system environment, including a system, that may align a plurality of variously encoded content streams, according to an example.

FIG. 2B illustrates a block diagram of the system that may align a plurality of variously encoded content streams, according to an example.

FIG. 2C illustrates a diagram of a system environment including a plurality of devices that may be utilized to synchronize audio and video data for a plurality of encodings, according to an example.

FIG. 3 illustrates a block diagram of a computer system to align a plurality of variously encoded content streams, according to an example.

FIG. 4 illustrate a method for aligning a plurality of variously encoded content streams, according to an example.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

Typically, a content platform having one or more content items may be provided by a service provider. As used herein, “digital content”, “digital content item” and “content item” may refer to any digital data (e.g., a data file). Examples of digital content items include, but are not limited to, digital images, digital video files, digital audio files, and/or streaming content. Examples of types of content that may be shared over various content platforms may include audio (e.g., podcasts, music), video (e.g., music videos, variety shows, sports, etc.), and text (e.g., micro-blogs, blogs, etc.).

In some examples, content items on a content platform may be shared by a first user to one or more other users of the content platform. As used herein, a “user” may include any user of a computing device or digital content delivery mechanism who receives or interacts with delivered content items, which may be visual, non-visual, or a combination thereof.

One content type often favored by users may be “live” content. As used herein, live content may include any content published in real-time. In some instances, users may prefer live content as it may offer an unfiltered and synchronous experience that may be authentic and compelling.

In some examples, to facilitate publication and distribution of live content (e.g., a live sporting event), a service provider may enable continuous transmission (e.g., “streaming” or “stream-casting”) of data over a content platform to a user. As used herein, “stream”, “streaming”, and “stream-casting” may be used interchangeably to refer to any continuous transmission of data to a device.

In some examples, to transmit a content item, a content provider may transmit data associated with video from the content item (e.g., “video data”) and/or data associated with audio from the content item (e.g., “audio data”). In particular, in some examples, the video data and the audio data may each be published in a particular standard or format, which may be referred to herein as “publication standard(s)” or “publication format(s).”

In some examples, a processing system may transcode video data and audio data associated with a content item in a “linear” (e.g., continuous) fashion. In some examples, to transcode a content item in a linear fashion, the centralized processing system may receive a first segment of audio data (or video data) from the content item, transcode the first segment to generate one of the one or more renditions, and follow the transcoding of the first segment with transcoding of a second, sequential segment of the audio data. In some examples, the centralized processing system may sequentially transmit the first segment and the second segment to one or more user devices for playback in a linear manner as well.

In some examples, a processing system may transcode video data and audio data in order to generate one or more renditions of a content item. In particular, in some examples and as will be discussed further below, the processing system may transcode the video data and the audio data to generate the one or more renditions of the content item in order to, among other things, accommodate various device types or media player specifications.

In some instances, video data may be published according to Advanced Video Coding (AVC) format. In some instances, the Advanced Video Coding (AVC) format may also be referred to as the “H264” format. In some examples, the Advanced Video Coding (AVC) format may employ one or more one or more instantaneous decoding refresh (IDR) frames. In some examples, an instantaneous decoding refresh (IDR) frame may represent a point in a stream of video data free from any dependencies associated with previous video data.

In some instances, audio data may be published according to the Advanced Audio Coding (AAC) format. In some examples, Advanced Audio Coding (AAC) may utilize one or more “frames” of audio data, wherein each frame may include a particular number (e.g., one thousand twenty-four (1024)) of samples of audio data.

In some examples, to generate a content item (e.g., a streaming content item), a plurality of audio and/or video encodings (e.g., encoded streams) may be provided. In some examples, the content item may be captured in a plurality of encoding versions.

In some instances, a plurality of audio and video encodings may implement redundancy, in that if a stream for one encoding may fail, another encoding may be made available. In some instances, this may be referred to as “active-passive,” wherein a first, “active” stream may be “backed-up” by a second, “passive” stream. In these instances, the second, “passive” stream may be ready in waiting to become active upon failure of the first, “active” stream.

In some examples, to transmit a content item, a plurality of audio and/or video encoding streams may be transmitted in one or more segments (or “chunks”) of audio and/or video data associated with a content item. In some examples, the one or more segments may be created with respect to increments of time (e.g., every ten (10) seconds).

It may be appreciated that, in some instances, switching from a first encoding stream to a second encoding stream may present difficulties. For example, in some instances, in implementing the switch, a media player may require some time to reconfigure from a first encoding configuration associated with the first encoding stream to a second encoding configuration associated with the second encoding stream.

In particular, in some instances, a first stream and a second stream may not be synchronous. That is, in some instances, an operational clock associated with the first encoding and an operational clock associated with the second encoding may be misaligned. In these instances, a particular data frame (e.g., a video frame) from the content item associated with the first encoding may not be aligned with a same data frame from the content item associated with the second encoding (e.g., not “frame-aligned”). In some examples, this may result in various improprieties, such as a temporal “jump” in video playback or a “glitch”/disruptions in audio playback.

In some examples, the systems and methods described herein may enable alignment of a plurality of variously encoded content streams. In some examples, the systems and methods may enable audio and video data alignment over multiple processing “pipelines”. Moreover, in some examples, the systems and methods may enable alignment of audio and video data associated with a plurality of encodings in real-time.

In some examples, the systems and methods may enable synchronization of audio and video data associated with a plurality of encodings by utilizing embedded information (e.g., data). In particular, in some examples, the systems and methods may utilize one or more types of signal information embedded in the audio and video data. In some examples, the systems and methods may utilize a Society of Motion Picture and Television Engineers (SMPTE) timecode (or “SMPTE timecode”).

In some examples, the systems and methods may implement an alignment element to utilize (among other things) signal information embedded in audio and video data. More specifically, in some examples, the systems and methods may implement one or more alignment element(s) to, among other things, extract embedded signal information and to utilize the embedded signal information to align multiple processing “pipelines”. Also, in some examples, the systems and methods may implement the one or more alignment element(s) to utilize signal information and to align multiple processing pipelines without requiring communication between the one or more alignment elements.

In some examples, the systems and methods may implement one or more alignment elements during a transcoding of audio and video data. In particular, and as will be discussed further below, in some examples, upon decoding of audio and/or video data, the one or more alignment elements may be implemented to align audio and video frames of one or more of a plurality of (variously encoded) content streams.

In some instances, the alignment elements that may be utilized to align of the plurality of content streams may be part of an “ingest” process. As will be discussed in further detail below, the alignment elements may be implemented in between decoding process and an encoding process. That is, upon aligning of a content stream of the plurality of content streams, the systems and methods may encode the aligned content stream. In some examples, the systems and methods may utilize the aligned content stream to generate one or more renditions (e.g., of different audio and video qualities), which may be transmitted to a variety of user devices for (selective) playback.

Furthermore, in some examples, the systems and methods may enable the plurality of alignment element(s) to utilize the embedded signal information to align multiple processing pipelines without requiring communication between devices that may generate the plurality of encodings. As a result, in some examples, the systems and methods may enable encoding selectivity (e.g., by a media player) between the multiple processing pipelines, and may provide an aligned plurality of encodings that may enable seamless alternating between the multiple processing pipelines as well.

In some examples, systems and methods described herein may include a system, comprising a processor and a memory storing instructions, which when executed by the processor, cause the processor to decode content data of a content item, the content data being associated with an encoding, extract signal information from the decoded content data, process the decoded content data to align with content data from one or more other encodings utilizing the signal information, process the decoded content data to be interchangeable with the content data from the one or more other encodings utilizing the extracted signal information, and deliver one or more aligned and interchangeable encodings to a content delivery network (CDN). In some examples, the instructions when executed by the processor further cause the processor to implement a filename convention to enable interchangeable playback of the content data from the encoding and the content data from the one or more other encodings, generate one or more timing markers, implement a timing criteria associated with the one or more timing markers, and implement an equivalence calculation to determine a time stamp for aligning the encoding and the one or more other encodings. In some examples, the equivalence calculation is based on a Society of Motion Picture and Television Engineers (SMPTE) timecode and the time stamp is a presentation time stamp (PTS). In some examples, the instructions when executed by the processor further cause the processor to implement a first aligner and a second aligner to process the decoded content data to align with content data from the one or more other encodings, wherein the first aligner and the second aligner operate independently of each other.

In some examples, the systems and methods may include a method, comprising decoding content data of a content item, the content data being associated with an encoding, extracting signal information from the decoded content data, processing the decoded content data to align with content data from one or more other encodings utilizing the extracted signal information, processing the decoded content data to be interchangeable with the content data from the one or more other encodings utilizing the extracted signal information, and delivering one or more aligned and interchangeable encodings to a content delivery network (CDN). In some examples, the method may include implementing a filename convention to enable interchangeable playback of the content data from the encoding and the content data from the one or more other encodings, generating one or more timing markers, implementing a timing criteria associated with the one or more timing markers, implementing an equivalence calculation to determine a time stamp for aligning the encoding and the one or more other encodings. In some examples, the equivalence calculation is based on a Society of Motion Picture and Television Engineers (SMPTE) timecode and the time stamp is a presentation time stamp (PTS). In some examples, the method may further include implementing a first aligner and a second aligner to process the decoded content data to align with content data from the one or more other encodings, wherein the first aligner and the second aligner operate independently of each other.

In some examples, the systems and methods described herein may include a non-transitory computer-readable storage medium having an executable stored thereon, which when executed instructs a processor to decode content data of a content item, the content data being associated with an encoding, extract signal information from the decoded content data, process the decoded content data to align with content data from one or more other encodings utilizing the extracted signal information, process the decoded content data to be interchangeable with the content data from the one or more other encodings utilizing the extracted signal information, and deliver one or more aligned and interchangeable encodings to a content delivery network (CDN). In some examples, the executable when executed further instructs a processor to implement a filename convention to enable interchangeable playback of the content data from the encoding and the content data from the one or more other encodings, generate one or more timing markers, implement a timing criteria associated with the one or more timing markers, implement an equivalence calculation to determine a time stamp for aligning the encoding and the one or more other encodings, and implement a first aligner and a second aligner to process the decoded content data to align with content data from the one or more other encodings, wherein the first aligner and the second aligner operate independently of each other. In some examples, the equivalence calculation is based on a Society of Motion Picture and Television Engineers (SMPTE) timecode.

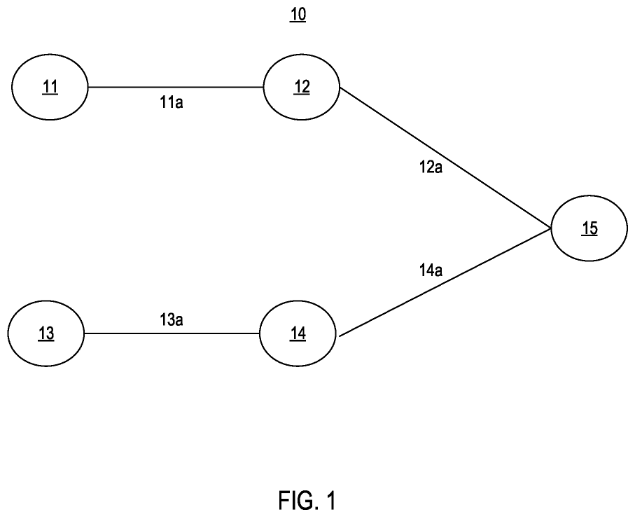

FIG. 1 illustrates a block diagram of a system environment 10 configured to align a plurality of variously encoded content streams, according to an example. In some examples, the system environment 10 may include a first source device 11, a first alignment element 12, a second source device 13, and a second alignment element 14. It may be appreciated that the system environment 10 may include any one or more alignment elements, depending (for example) on a number of encodings that may be aligned.

In some examples, the first source device 11 may generate and transmit a first encoding (or “encoded stream”) 11a, and may implement a first operational clock to produce the first encoding 11a. Also, in some examples, the second source device 13 may generate and transmit a second encoding 13a, and may implement a second operational clock to produce the second encoding 13a.

In some examples, the first source device 11 may transmit the first encoding 11a to the first alignment element 12. Also, in some examples, the second source device 13 may transmit the second encoding 13a to the second alignment element 14. In some examples, the first source device 11 and the second source device 13 may be synchronized with an input signal, in that they may output a same number of frames as they may receive. Moreover, in some examples, the first source device 11 and the second source device 13 may introduce a same delay for audio and a same delay for video, while in other examples the first source device 11 and the second source device 13 may not introduce any delay for audio or any delay for video.

In some examples, the first alignment element 12 may access embedded signal information from the first encoding 11a and the second alignment element 14 may access embedded signal information from the second encoding 13a. Furthermore, in some examples, the first alignment element 12 may utilize the embedded signal information from the first encoding 11a to generate a first aligned encoding 12a. In some examples, the second alignment element 14 may utilize the embedded signal information from the second encoding 13a to generate a second aligned encoding 14a. In some examples, one or more of the first aligned encoding 12a and the second aligned encoding 14a may be transmitted to a media player located at a user device 15, where the media player may be able to select from the first aligned encoding 12a and the second aligned encoding 14a for playback.

In some examples, the first aligned encoding 12a and the second aligned encoding 14a may be aligned (e.g., temporally aligned) and may be selectively employed, seamlessly and without interruption by a playback component (e.g., a media player). Accordingly, in some examples and as will be discussed in greater detail below, the system environment 10 may provide an “active-active” implementation, wherein a media player enabling playback of a content item associated with the first aligned encoding 12a and the second aligned encoding 14a may be able to “choose” between the first aligned encoding 12a and the second aligned encoding 14a as may be appropriate and/or optimal.

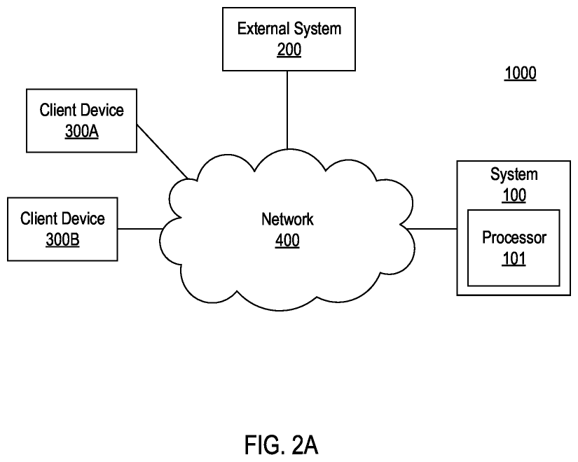

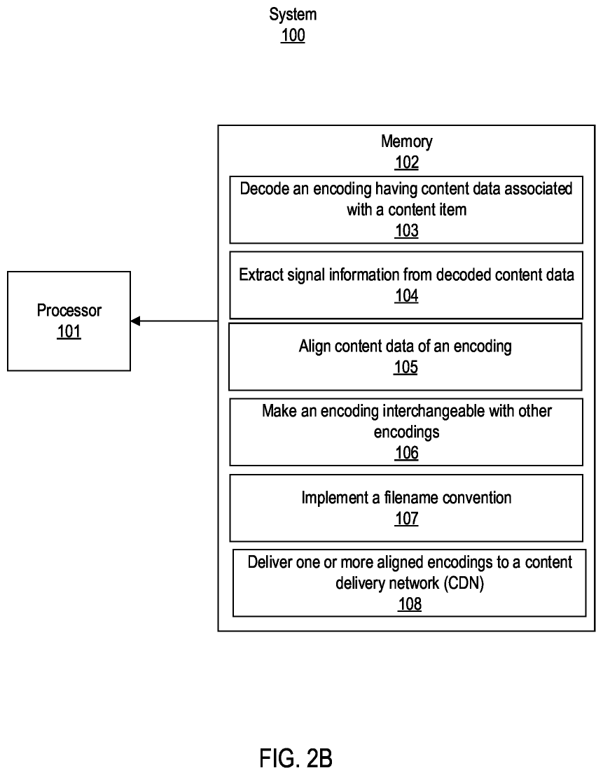

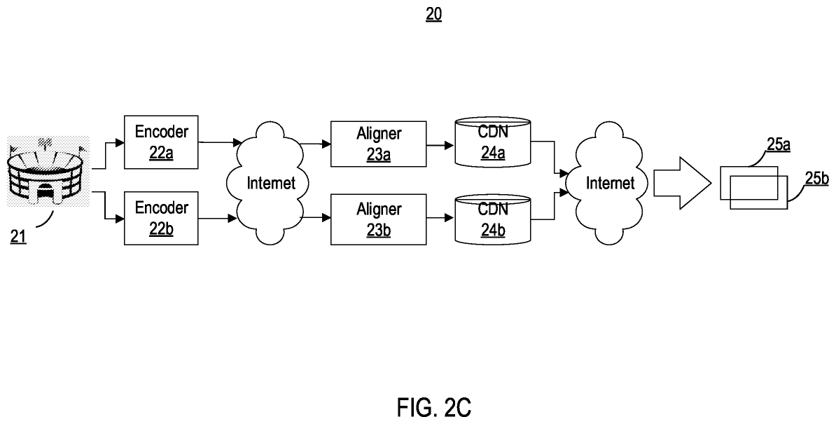

Reference is now made to FIGS. 2A-2C. FIGS. 2A-2C illustrate various aspects of one or more system environments, including one or more systems, that may synchronize audio and video data for a plurality of encodings. In particular, FIG. 2A illustrates a block diagram of a system environment, including a system, that may synchronize audio and video data for a plurality of encodings, according to an example. FIG. 2B illustrates a block diagram of the system that may synchronize audio and video data for a plurality of encodings, according to an example. FIG. 2C illustrates a diagram of a system environment including a plurality of devices that may be utilized to synchronize audio and video data for a plurality of encodings, according to an example.

As will be described in the examples below, one or more of system 100, external system 200, user devices 300A-300B and system environment 1000 shown in FIGS. 2A-2C may be operated by a service provider to synchronize audio and video data for a plurality of encodings. It should be appreciated that one or more of the system 100, the external system 200, the user devices 300A-300B and the system environment 1000 depicted in FIGS. 2A-2B may be provided as examples. Thus, one or more of the system 100, the external system 200 the user devices 300A-300B and the system environment 1000 may or may not include additional features and some of the features described herein may be removed and/or modified without departing from the scopes of the system 100, the external system 200, the user devices 300A-300B and the system environment 1000 outlined herein. Moreover, in some examples, the system 100, the external system 200, and/or the user devices 300A-300B may be or associated with a social networking system, a content sharing network, an advertisement system, an online system, and/or any other system that facilitates any variety of digital content in personal, social, commercial, financial, and/or enterprise environments.

While the servers, systems, subsystems, and/or other computing devices shown in FIGS. 2A-2C may be shown as single components or elements, it should be appreciated that one of ordinary skill in the art would recognize that these single components or elements may represent multiple components or elements, and that these components or elements may be connected via one or more networks. Also, middleware (not shown) may be included with any of the elements or components described herein. The middleware may include software hosted by one or more servers. Furthermore, it should be appreciated that some of the middleware or servers may or may not be needed to achieve functionality. Other types of servers, middleware, systems, platforms, and applications not shown may also be provided at the front-end or back-end to facilitate the features and functionalities of the system 100, the external system 200, the user devices 300A-300B or the system environment 1000.

It should also be appreciated that the systems and methods described herein may be particularly suited for digital content, but are also applicable to a host of other distributed content or media. These may include, for example, content or media associated with data management platforms, search or recommendation engines, social media, and/or data communications involving communication of potentially personal, private, or sensitive data or information. These and other benefits will be apparent in the descriptions provided herein.

In some examples, the external system 200 may include any number of servers, hosts, systems, and/or databases that store data to be accessed by the system 100, the user devices 300A-300B, and/or other network elements (not shown) in the system environment 1000. In addition, in some examples, the servers, hosts, systems, and/or databases of the external system 200 may include one or more storage mediums storing any data. In some examples, and as will be discussed further below, the external system 200 may be utilized to store any information. As will be discussed further below, in other examples, the external system 200 may be utilized by a service provider (e.g., a social media application provider) as part of a data storage, wherein a service provider may access data on the external system 200 to generate and deliver a content item to one or more user devices.

In some examples, the user devices 300A-300B may be electronic or computing devices configured to transmit and/or receive data. In this regard, each of the user devices 300A-300B may be any device having computer functionality, such as a television, a radio, a smartphone, a tablet, a laptop, a watch, a desktop, a server, encoder, or other computing or entertainment device or appliance. In some examples, the user devices 300A-300B may be mobile devices that are communicatively coupled to the network 400 and enabled to interact with various network elements over the network 400. In some examples, the user devices 300A-300B may execute an application allowing a user of the user devices 300A-300B to interact with various network elements on the network 400. Additionally, the user devices 300A-300B may execute a browser or application to enable interaction between the user devices 300A-300B and the system 100 via the network 400.

Moreover, in some examples and as will also be discussed further below, the user devices 300A-300B may be utilized by a user viewing content (e.g., a live sporting event) distributed by a content platform provider, wherein information relating to the user may be stored and transmitted by the user devices 300A to other devices, such as the external system 200. In some examples, and as will described further below, a user may utilize the user device 300A to receive a content item associated with a content platform. Also, in some examples, by a user utilizing the user device 300B may utilize the user device 300B to provide feedback (e.g., a comment) associated with the content item associated with the content platform as well.

The system environment 1000 may also include the network 400. In operation, one or more of the system 100, the external system 200 and the user devices 300A-300B may communicate with one or more of the other devices via the network 400. The network 400 may be a local area network (LAN), a wide area network (WAN), the Internet, a cellular network, a cable network, a satellite network, or other network that facilitates communication between, the system 100, the external system 200, the user devices 300A-300B and/or any other system, component, or device connected to the network 400. The network 400 may further include one, or any number, of the exemplary types of networks mentioned above operating as a stand-alone network or in cooperation with each other. For example, the network 400 may utilize one or more protocols of one or more clients or servers to which they are communicatively coupled. The network 400 may facilitate transmission of data according to a transmission protocol of any of the devices and/or systems in the network 400. Although the network 400 is depicted as a single network in the system environment 1000 of FIG. 2A, it should be appreciated that, in some examples, the network 400 may include a plurality of interconnected networks as well.

In some examples, and as will be discussed further below, the system 100 may synchronize audio and video data associated with a plurality of encodings. Details of the system 100 and its operation within the system environment 1000 will be described in more detail below.

As shown in FIGS. 2A-2B, the system 100 may include processor 101 and the memory 102. In some examples, the processor 101 may execute the machine-readable instructions stored in the memory 102. It should be appreciated that the processor 101 may be a semiconductor-based microprocessor, a central processing unit (CPU), an application specific integrated circuit (ASIC), a field-programmable gate array (FPGA), and/or other suitable hardware device.

In some examples, the memory 102 may have stored thereon machine-readable instructions (which may also be termed computer-readable instructions) that the processor 101 may execute. The memory 102 may be an electronic, magnetic, optical, or other physical storage device that contains or stores executable instructions. The memory 102 may be, for example, random access memory (RAM), an Electrically Erasable Programmable Read-Only Memory (EEPROM), a storage device, an optical disc, or the like. The memory 102, which may also be referred to as a computer-readable storage medium, may be a non-transitory machine-readable storage medium, where the term “non-transitory” does not encompass transitory propagating signals. It should be appreciated that the memory 102 depicted in FIGS. 2A-2B may be provided as an example. Thus, the memory 102 may or may not include additional features, and some of the features described herein may be removed and/or modified without departing from the scope of the memory 102 outlined herein.

It should be appreciated that, and as described further below, the processing performed via the instructions on the memory 102 may or may not be performed, in part or in total, with the aid of other information and data, such as information and data provided by the external system 200 and/or the user devices 300A-300B. Moreover, and as described further below, it should be appreciated that the processing performed via the instructions on the memory 102 may or may not be performed, in part or in total, with the aid of or in addition to processing provided by other devices, including for example, the external system 200 and/or the user devices 300A-300B.

In some examples, the memory 102 may store instructions, which when executed by the processor 101, may cause the processor to: decode an encoding having content data associated with a content item; extract signal information from decoded content data; align content data of an encoding; modify embedded content data signaling to make an encoding interchangeable with other encodings; implement a filename convention; and deliver one or more aligned encodings to a content delivery network (CDN).

Furthermore, in some examples, the instructions 103-108 may be executed in association with one or more alignment elements (e.g., similar to the alignment elements 12, 14 in FIG. 1). In particular, in some examples, a first alignment element of the one or more alignment elements may be operated in association with a first encoding stream, wherein a second alignment element of the one or more alignment elements may be operated in association with a second encoding stream.

In some examples, and as discussed further below, the instructions 103-108 on the memory 102 may be executed alone or in combination by the processor 101 to synchronize audio and video data associated with a plurality of encodings. In some examples, the instructions 103-108 may be implemented in association with a content platform configured to provide content for users, while in other examples, the instructions 103-108 may be implemented as part of a stand-alone application.

Additionally, and as described above, it should be appreciated that to provide generation and delivery of content, instructions 103-108 may utilize various artificial intelligence (AI) and machine learning (ML) based tools. For instance, these artificial intelligence (AI) and machine learning (ML) based tools may be used to generate models that may include a neural network (e.g., a recurrent neural network (RNN)), generative adversarial network (GAN), a tree-based model, a Bayesian network, a support vector, clustering, a kernel method, a spline, a knowledge graph, or an ensemble of one or more of these and other techniques. It should also be appreciated that the system 100 may provide other types of machine learning (ML) approaches as well, such as reinforcement learning, feature learning, anomaly detection, etc.

In some examples, the instructions 103 may decode an encoding having content data (e.g., audio data and/or video data) associated with a (particular) content item. In some examples, as illustrated in FIG. 2C, a content item (e.g., a stream-casting of a live sporting event) may be generated from an event location 21, wherein a first encoder 22a may encode a first encoding stream (e.g., to be decoded via the instructions 103) and a second encoder 22b may encode a second encoding stream (e.g., to be decoded via the instructions 103).

In some examples and as will be discussed further below, the instructions 103 may be executed in association with operation of one or more alignment elements configured to align a plurality of variously encoded content streams (e.g., the alignment elements 12, 14 in FIG. 1). For example, as shown in FIG. 2C, a first alignment element 23a may align a first encoding (or “encoding stream”) from the first encoder 22a, while a second alignment element 23b may align a second encoding from the second encoder 22b.

In particular, in some examples, the instructions 103 may decode an encoding (e.g., the first encoding 11a in FIG. 1) from a source device (e.g., the first source device 11 in FIG. 1). In some examples, the audio data may be encoded in Advanced Audio Coding (AAC) format, and the video data may be encoded in Advanced Audio Coding (AVC) format.

In some examples, the instructions 104 may extract signal information from decoded content data, including audio data and/or video data (e.g., as provided via the instructions 103). In some examples, the audio data and/or video data may be associated with a (particular) content item. As discussed above, in some examples, the instructions 104 may be executed in association with operation of one or more alignment elements configured to align a plurality of variously encoded content streams (e.g., the alignment elements 12, 14 in FIG. 1).

In some examples, the instructions 104 may extract a Society of Motion Picture and Television Engineers (SMPTE) timecode. In some examples, a Society of Motion Picture and Television Engineers (SMPTE) timecode may be inserted during creation of the content item. For example, in some instances, the Society of Motion Picture and Television Engineers (SMPTE) timecode may be included as part of the production process.

In some examples, the Society of Motion Picture and Television Engineers (SMPTE) timecode may include information associated with timing and/or frames of a content item. In particular, in some examples, the Society of Motion Picture and Television Engineers (SMPTE) timecode may include content information such as an hour mark, a minute mark, a second mark, and/or a frame identifier (e.g., for a content item), associated with a particular portion of content data from the content item, along with associated metadata.

In some examples, the instructions 105 may align content data of an encoding. In particular, as will be discussed in further detail below, the instructions 105 may process decoded content data (e.g., as provided via the instructions 103) with the aim to produce an aligned encoding. Moreover, in some examples, the instructions 105 may be executed in association with operation of one or more alignment elements to align a plurality of variously encoded content streams (e.g., the alignment elements 12, 14 in FIG. 1).

In some examples, to align content data, the instructions 105 may generate (e.g., calculate) one or more timing markers. As used herein, a “timing marker” may be any number or descriptor that may be associated with an aspect of timing of a content item.

In some examples, a timing element that may be utilized to generate one or more timing markers may be a Society of Motion Picture and Television Engineers (SMPTE) timecode. In some examples, to generate the one or more timing markers, the instructions 105 may utilize an extracted Society of Motion Picture and Television Engineers (SMPTE) timecode (e.g., as extracted via the instructions 104).

In some examples, in aligning a content item, the instructions 105 may utilize a mathematical function (e.g., a modulus operation) to generate one or more timing markers. As discussed above, in some examples, a Society of Motion Picture and Television Engineers (SMPTE) timecode may contain information such as an hour mark, a minute mark, a second, and frames mark (e.g., for a content item), that may be used as a frame identifier associated with a particular portion of content data from the content item. In some examples, the instructions 105 may implement a mathematical function to convert the hours, minutes, seconds, and frames, or other identifier information for the frame of content data from the content item into an integer. In one example, where the instructions 105 may determine that an extracted Society of Motion Picture and Television Engineers (SMPTE) timecode for a content frame may be 23 hours, 45 minutes, 34 seconds, and 10 frames (e.g., 23:45:34:10), and the content data received is 25 frames per second, the instructions may utilize numerical values associated with the timecode and the frames per second to generate a corresponding timing marker “2318360” (25*60*60*25+45*60*25+34*25+10) for the content frame.

In addition, in some examples, to align a content item, the instructions 105 may implement a timing criteria. In particular, in some examples, the instructions 105 may implement the timing criteria to determine if a particular timing marker may “satisfy” a timing criteria.

In some examples, the instructions 105 may implement a timing criteria that may take a form of a mathematical function. So, in an example where the timing criteria may include determining if a particular timing maker may be a multiple of a predetermined number (e.g., ten (10), one hundred (100), etc.), the instructions 105 may determine if each of one or more generated timing markers may be a multiple of the predetermined number. Accordingly, in an example where the timing criteria may entail determining if a timing marker may be a multiple of one-hundred (100), the instructions 105 may determine that a timing marker with a value of five-hundred (500) may satisfy the associated timing criteria. It may be appreciated that a variety of other timing criteria may be implemented as well.

In some examples, the instructions 105 may utilize one or more timing markers and one or more timing criteria to align a plurality of variously encoded content streams. In particular, the instructions 105 may determine that for each increment of a predetermined number of frames (e.g., each increment of one hundred (100) frames), a frame of content data from a that encoding may be a segment boundary.

Furthermore, in some examples, upon determining that a timing criteria may be met, the instructions 105 may determine that a particular frame may serve as a marker frame for an associated encoding. As used herein, a “marker frame” may refer a frame that may satisfy a timing criteria to create a segment boundary.

As used herein, an “equivalent frame” may include a frame from a specific encoding stream that may contain the same content data than other encoding streams. In some examples, an equivalent frame may include a frame of content data that may represent a same content as content represented in a marker frame. In some examples, the equivalent frame determined by the instructions 105 may have a same timing value as a timing value for the marker frame. Also, in some examples, the equivalent frame determination performed by the instructions 105 may be in association with other criteria as well.

It may be appreciated that because different connections and/or operational latencies, a marker frame (of the first encoding) and an equivalent frame (of one or more other encodings) may arrive at different times. Nevertheless, in some examples, the instructions 105 may utilize the marker frame of the first encoding and the equivalent frame of the one or more other encodings to align the first encoding and the one or more other encodings in a totally independent and disconnected way.

In some examples, in aligning a content item, the instructions 105 may discard one or more frames of content data associated with a content item until a timing criteria may be met. In particular, in some examples, the instructions 105 may discard any number of frames of content data received from an encoding and any number of frames of content data received from one or more other encodings until the timing criteria may be met. In some examples, the discarded frames of content data may be from a beginning of a content stream.

In some examples, upon aligning a first encoding and one or more other encodings (e.g., as provided via the instructions 105), the instructions 106 may enable a first encoding to be interchangeable with one or more other encodings. That is, in some examples, the instructions 106 may process decoded content data (e.g., as provided via the instructions 103) to produce interchangeable content data between one or more other encodings.

As used herein, a first encoding may be “interchangeable” with one or more other encodings if a switch (as described above) between the first encoding and the one or more other encodings may be accomplished without impact on a user experience. For example, when switching an interchangeable first encoding with one or more other interchangeable encodings, the user may not perceive a temporal “jump” in video playback and a “glitch” in audio playback. By ensuring the first encoding may be interchangeable with one or more other encodings, in some examples, the instructions 106 may enable selectivity between the first encoding and the one or more other encodings while providing a continuous and seamless playback. In some examples, the instructions 106 may be executed in association with operation of one or more alignment elements configured to align a plurality of variously encoded content streams (e.g., the alignment elements 12, 14 in FIG. 1).

In some examples, to provide that a first encoding may be interchangeable with one or more other encodings, the instructions 106 may access signal information from the decoded content data (e.g., as provided via the instructions 103). In particular, in some examples, the instructions 106 may access one or more presentation time stamps (PTSs) associated with the encoding. In some examples and/or in the alternative, the instructions 106 may access a decode time stamp (DTS) associated with the encoding. It should be appreciated that an aligner, as implemented via or in concert with the instructions 106, may only have access to one encoding, wherein a plurality of (e.g., different) encodings from a same content item may be aligned utilizing a respective aligner acting independently (e.g., not cooperatively and/or in communication with each other).

In some examples, to provide a first encoding that may be interchangeable with one or more other encodings, the instructions 106 may ensure that a presentation time stamp (PTS) and decoding time stamp (DTS) across all encodings align. In some examples, this may mean that equivalent frames across all encodings may have same presentation time stamp (PTS) and decoding timestamps (DTS).

In some examples, a presentation time stamp (PTS) and decoding time stamp (DTS) for equivalent frames across encodings may not align. In some examples, this may mean that equivalent frames from different encodings may have different presentation time stamp (PTS) and decoding time stamp (DTS). In some examples, the instructions 106 may utilize a marker frame of the encoding (e.g., as determined via the instructions 105). In particular, the instructions 106 may rewrite presentation time stamp (PTS) and decoding time stamps (DTS) using the marker (e.g., as determined via the instructions 105), and then the instructions 106 may provide that the first encoding may be interchangeable with the other encodings.

In some examples, since the Society of Motion Picture and Television Engineers (SMPTE) timecode may be the same for equivalent frames across all encodings, the instructions 106 may utilize this number to generate a (new) presentation time stamp (PTS) and decoding time stamp (DTS) that may be utilized to align a first encoding and one or more other encodings.

By way of an example, to provide that a first encoding and one or more other encodings may be interchangeable, the instructions 106 may implement an equivalence calculation to associate an equivalence between a first encoding and one or more other encodings. In some examples, to implement an equivalence calculation, the instructions 106 may utilize the Society of Motion Picture and Television Engineers (SMPTE) timecode. So, in some examples, an equivalence calculation provided via the instructions 106 may include multiplying a Society of Motion Picture and Television Engineers (SMPTE) timecode in its integer form by the timebase of the given stream. So, by way of example, if the Society of Motion Picture and Television Engineers (SMPTE) timecode for the first frame in its integer form may be ten (10) and the video timebase may be ninety thousand (90000), the (new) presentation time stamp (PTS) for aligning the first encoding and the one or more other encodings may be nine hundred thousand (900,0000). It may be appreciated that, in some examples, the instructions 106 may be configured to implement similar operations with respect to a decode time stamp (DTS) associated with the first encoding and a decode time stamp (DTS) associated with the second encoding as well.

In some examples, the instructions 107 may deliver aligned content data (e.g., as provided by the instructions 106) in segments, wherein those segments may be considered independent files (e.g., ten (10) seconds of content each). In order to facilitate the interchangeability of those segments, the instructions 107 may implement a filename convention so that the one or more segments associated to the first encoding may be played (e.g., played back) interchangeably with other segments associated with the one or more other encodings. In particular, in some examples, the instructions 107 may implement the filename name convention so that a content delivery network (CDN) may determine (and implement) a uniformity and/or an interchangeability of segments (for playback) between the first encoding and the one or more other encodings. In some examples, the instructions 107 may be executed in association with operation of one or more alignment elements configured to align a plurality of variously encoded content streams (e.g., the alignment elements 12, 14 in FIG. 1).

In some examples, where the one or more segments associated with the first encoding and the one or more segments associated with the one or more other encodings may be associated with a same content portion of a content item, the instructions 107 may implement the filename convention to provide a same filename for the one or more segments associated with the first encoding and the one or more segments associated with the one or more other encodings. In particular, in some examples, since the one or more segments associated with the first encoding and the one or more segments associated with the one or more other encodings may have an aligned (e.g., same) timecode (e.g., as provided by the instructions 105), the instructions 107 may utilize the aligned timecode to generate a same filename for the one or more segments associated with the first encoding and the one or more segments associated with the one or more other encodings. By way of example, where a particular timecode for the first frame of a segment associated with the first encoding may be one hour, twenty minutes, thirty seconds, and ten frames (e.g., 1:20:30:10), the instructions 107 may utilize the associated timecode to generate a filename of “id-01203010.”

Also, in some examples, the instructions 107 may provide a filename extension as well. In addition, the instructions 107 may also be configured to utilize “.ts” as a filename extension, wherein in the example above, the instructions 107 may generate a filename of “id-01203010.ts.”

Accordingly, in some examples, the instructions 104-107 may generate one or more segments associated with a first encoding that may be temporally aligned, identically named, and interchangeable with one or more segments associated with one or more other encodings. In addition, in some examples, it may be appreciated that the one or more segments associated with the first encoding and the one or more segments associated with the one or more other encodings may have a same presentation time stamp (PTS) and decoding time stamp (DTS) for equivalent frames.

In some examples, the instructions 107 may utilize one or more segments associated with a first encoding and one or more segments associated with one or more other encodings to generate (e.g., transcode) one or more renditions (as described above). In some examples, to generate the one or more renditions, the instructions 107 may implement one or more transcoding chunk techniques and/or an adaptive bitrate (ABR). In some examples, adaptive bitrate may include one or more content streaming techniques that may allow multiple different video renditions in different resolutions and bitrates to be made available to a media player.

In particular, the instructions 107 may enable an associated encoder to encode the one or more renditions to implement a same filename (e.g., rendition720p/id-10000000.ts, rendition1080p/id-10000000.ts, etc.) for same renditions lanes, and same presentation time stamp (PTS) and/or decoding time stamp (DTS) for segments associated with the first encoding (e.g., across all renditions) and segments associated with the one or more other encodings (across all renditions). Accordingly, in some examples, the instructions 107, and indeed the instructions 104-107, may enable an “redundant” and “active-active” system that will avoid switching between encodings and enable an associated media player to select a best available encoding option that may be available at a time.

In some examples, the instructions 108 may be configured to deliver one or more aligned encodings to a content delivery network (CDN). In some examples, the instructions 108 may deliver one or more renditions (e.g., as generated via the instructions 107) to a server that may serve aligned data segments from a plurality of variously encoded streams to user devices for playback. In some examples, as shown in FIG. 2C, the instructions 108 may deliver the aligned data segments from a plurality of variously encoded streams to a content delivery network (CDN) 24a and a content delivery network (CDN) 24b, which may distribute the aligned data segments to a plurality of media players 25a-25b of various user devices for playback.

In some examples, the instructions 108 may cache aligned data frames in a content delivery network (CDN). In some examples, the content delivery network (CDN) may include numerous computers that may be networked to serve a one or more content items. In some examples, the instructions 108 may cache the aligned data frames from the plurality of encodings in order to serve requests from various user devices for playback on associated media players.

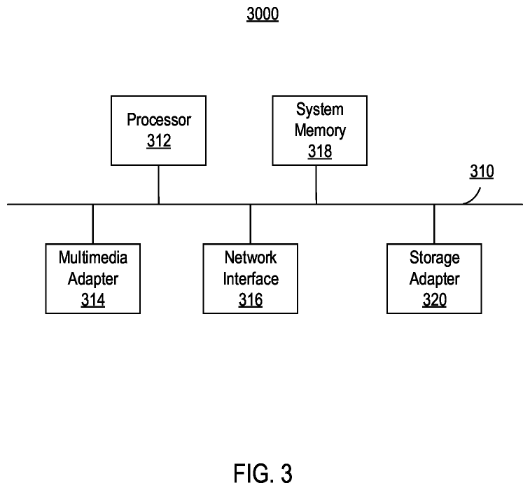

FIG. 3 illustrates a block diagram of a computer system to synchronize audio and video data for a plurality of encodings, according to an example. In some examples, the system 3000 may be associated the system 100 to perform the functions and features described herein. The system 3000 may include, among other things, an interconnect 310, a processor 312, a multimedia adapter 314, a network interface 316, a system memory 318, and a storage adapter 320.

The interconnect 310 may interconnect various subsystems, elements, and/or components of the external system 300. As shown, the interconnect 310 may be an abstraction that may represent any one or more separate physical buses, point-to-point connections, or both, connected by appropriate bridges, adapters, or controllers. In some examples, the interconnect 310 may include a system bus, a peripheral component interconnect (PCI) bus or PCI-Express bus, a HyperTransport or industry standard architecture (ISA)) bus, a small computer system interface (SCSI) bus, a universal serial bus (USB), IIC (12C) bus, or an Institute of Electrical and Electronics Engineers (IEEE) standard 1394 bus, or “firewire,” or other similar interconnection element.

In some examples, the interconnect 310 may allow data communication between the processor 312 and system memory 318, which may include read-only memory (ROM) or flash memory (neither shown), and random access memory (RAM) (not shown). It should be appreciated that the RAM may be the main memory into which an operating system and various application programs may be loaded. The ROM or flash memory may contain, among other code, the Basic Input-Output system (BIOS) which controls basic hardware operation such as the interaction with one or more peripheral components.

The processor 312 may be the central processing unit (CPU) of the computing device and may control overall operation of the computing device. In some examples, the processor 312 may accomplish this by executing software or firmware stored in system memory 318 or other data via the storage adapter 320. The processor 312 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

The multimedia adapter 314 may connect to various multimedia elements or peripherals. These may include devices associated with visual (e.g., video card or display), audio (e.g., sound card or speakers), and/or various input/output interfaces (e.g., mouse, keyboard, touchscreen).

The network interface 316 may provide the computing device with an ability to communicate with a variety of remote devices over a network (e.g., network 400 of FIG. 1A) and may include, for example, an Ethernet adapter, a Fibre Channel adapter, and/or other wired- or wireless-enabled adapter. The network interface 316 may provide a direct or indirect connection from one network element to another, and facilitate communication and between various network elements.

The storage adapter 320 may connect to a standard computer-readable medium for storage and/or retrieval of information, such as a fixed disk drive (internal or external).

Many other devices, components, elements, or subsystems (not shown) may be connected in a similar manner to the interconnect 310 or via a network (e.g., network 400 of FIG. 1A). Conversely, all of the devices shown in FIG. 3 need not be present to practice the present disclosure. The devices and subsystems can be interconnected in different ways from that shown in FIG. 3. Code to implement the dynamic approaches for payment gateway selection and payment transaction processing of the present disclosure may be stored in computer-readable storage media such as one or more of system memory 318 or other storage. Code to implement the dynamic approaches for payment gateway selection and payment transaction processing of the present disclosure may also be received via one or more interfaces and stored in memory. The operating system provided on system 100 may be MS-DOS, MS-WINDOWS, OS/2, OS X, 10S, ANDROID, UNIX, Linux, or another operating system.

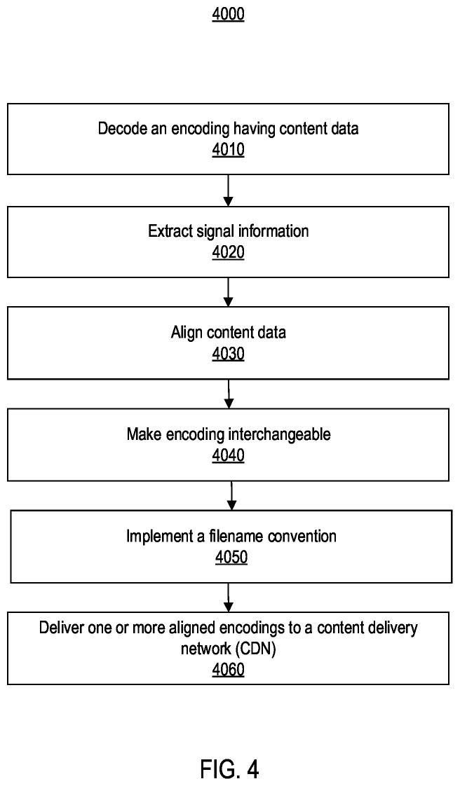

FIG. 4 illustrate a method for synchronize audio and video data for a plurality of encodings, according to an example. The method 4000 is provided by way of example, as there may be a variety of ways to carry out the method described herein. Each block shown in FIG. 4 may further represent one or more processes, methods, or subroutines, and one or more of the blocks may include machine-readable instructions stored on a non-transitory computer-readable medium and executed by a processor or other type of processing circuit to perform one or more operations described herein.

Although the method 4000 is primarily described as being performed by system 100 as shown in FIGS. 2A-2B, the method 4000 may be executed or otherwise performed by other systems, or a combination of systems. It should be appreciated that, in some examples, to generate audio and video content based on text content, the method 4000 may be configured to incorporate artificial intelligence (AI) or deep learning techniques, as described above. It should also be appreciated that, in some examples, the method 4000 may be implemented in conjunction with a content platform (e.g., a social media platform) to generate and deliver content.

Reference is now made with respect to FIG. 4. In some examples, to implement the steps 4010-4060, the processor 101 may be executed in association with operation of one or more alignment elements configured to align a plurality of variously encoded content streams (e.g., the alignment elements 12, 14 in FIG. 1).

At 4010, in some examples, the processor 101 may decode an encoding having content data (e.g., audio data and/or video data) associated with a (particular) content item. As discussed above, in some examples, the processor 101 may operate in association with an alignment element to align a plurality of variously encoded content streams (e.g., the alignment elements 12, 14 in FIG. 1).

At 4020, in some examples, the processor 101 may extract signal information from decoded content data. In some examples, the processor 101 may extract a Society of Motion Picture and Television Engineers (SMPTE) timecode.

At 4030, in some examples, the processor 101 may align content data from a first encoding with content data from one or more other encodings. In some examples, to align content data, the processor 101 may generate (e.g., calculate) one or more timing markers. In addition, in some examples, to align a content item, the processor 101 may implement a timing criteria that may take a form of a mathematical function. In some examples and as will be discussed further below, the processor 101 may utilize one or more timing markers and one or more timing criteria to align a plurality of variously encoded content streams.

In some examples, upon determining that a timing criteria may be met, the processor 101 may determine that a particular frame may serve as a marker frame for an associated encoding. In some examples, the processor 101 may utilize one or more of a marker frame in a first encoding along with a timing marker associated with the marker frame in order to determine an equivalent frame in the one or more other encodings. In some examples, at the beginning of the streams the processor 101 may discard one or more frames of content data associated with a content item until a timing criteria may be met.

At 4040, in some examples, upon aligning an encoding, the processor 101 may make the encoding interchangeable. In particular, in some examples, the processor 101 may enable a first encoding to be interchangeable with one or more other encodings. In some examples, to provide a first encoding interchangeable with one or more other encodings, the processor 101 may ensure that a presentation time stamp (PTS) and decoding time stamp (DTS) for a frame associated with a first encoding (e.g., the “first frame”) may be same as a presentation time stamp (PTS) and decoding time stamp (DTS) for an equivalent frame associated with a second encoding (e.g., the “second frame”). In some examples, to provide that a presentation time stamp (PTS) and decoding time stamps (DTS) for a first frame may be same as a presentation time stamp (PTS) and decoding time stamps (DTS) for a second frame, the processor 101 may utilize a marker frame of a first encoding (e.g., as determined via the processor 101) and an equivalent frame of one or more other encodings (e.g., as determined via the processor 101). In some examples, the processor 101 may utilize a Society of Motion Picture and Television Engineers (SMPTE) timecode associated with a first frame and a Society of Motion Picture and Television Engineers (SMPTE) timecode associated with a second frame (e.g., equivalent) to generate a presentation time stamp (PTS) and decoding time stamps (DTS) for the first frame and a presentation time stamp (PTS) and decoding time stamps (DTS) for the second frame.

At 4050, in some examples, the processor 101 may implement a filename convention in association with a segment of a first encoding and a segment of one or more other encodings. That is, in some examples, the processor 101 may implement a filename convention so the one or more segments associated with the first encoding may be played (e.g., playback) in association with the one or more segments associated with the one or more other encodings.

In particular, in some examples, the processor 101 may determine that the one or more segments associate with the first encoding may be interchangeable with the one or more segments associated with the one or more other encodings. Also, in some examples, the processor 101 may provide a filename extension as well.

At 4060, in some examples, the processor 101 may deliver one or more aligned encodings to a content delivery network (CDN). In some examples, the processor 101 may cache the aligned data segments from the plurality of encodings in order to serve requests from user devices for playback on associated media players.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

1. A system, comprising:
a processor; and
a memory storing instructions, which when executed by the processor, cause the processor to:
decode content data of a content item, the content data being associated with an encoding;
extract signal information from the decoded content data;
process the decoded content data to align with content data from one or more other encodings utilizing the signal information;
process the decoded content data to be interchangeable with the content data from the one or more other encodings utilizing the extracted signal information; and
deliver one or more aligned and interchangeable encodings to a content delivery network (CDN).

2. The system of claim 1, wherein the instructions when executed by the processor further cause the processor to implement a filename convention to enable interchangeable playback of the content data from the encoding and the content data from the one or more other encodings.

3. The system of claim 1, wherein to process the decoded content data, the instructions when executed cause the processor to:
generate one or more timing markers; and
implement a timing criteria associated with the one or more timing markers.

4. The system of claim 1, wherein the instructions when executed by the processor further cause the processor to:
determine a time stamp for aligning the encoding and the one or more other encodings.

5. The system of claim 4, wherein the time stamp is determined based on a Society of Motion Picture and Television Engineers (SMPTE) timecode.

6. The system of claim 4, wherein the time stamp is a presentation time stamp (PTS).

7. The system of claim 1, wherein the instructions when executed by the processor further cause the processor to:
implement a first aligner and a second aligner to process the decoded content data to align with content data from the one or more other encodings, wherein the first aligner and the second aligner operate independently of each other.

8. A method aligning a plurality of variously encoded content streams, comprising:
decoding content data of a content item, the content data being associated with an encoding;
extracting signal information from the decoded content data;
processing the decoded content data to align with content data from one or more other encodings utilizing the extracted signal information;
processing the decoded content data to be interchangeable with the content data from the one or more other encodings utilizing the extracted signal information; and
delivering one or more aligned and interchangeable encodings to a content delivery network (CDN).

9. The method of claim 8, further comprising:
implementing a filename convention to enable interchangeable playback of the content data from the encoding and the content data from the one or more other encodings.

10. The method of claim 8, further comprising:
generating one or more timing markers; and
implementing a timing criteria associated with the one or more timing markers.

11. The method of claim 8, further comprising:
determine a time stamp for aligning the encoding and the one or more other encodings.

12. The method of claim 11, wherein the time stamp is determined based on a Society of Motion Picture and Television Engineers (SMPTE) timecode.

13. The method of claim 11, wherein the time stamp is a presentation time stamp (PTS).

14. The method of claim 8, further comprising:
implementing a first aligner and a second aligner to process the decoded content data to align with content data from the one or more other encodings, wherein the first aligner and the second aligner operate independently of each other.

15. A non-transitory computer-readable storage medium having an executable stored thereon, which when executed instructs a processor to:
decode content data of a content item, the content data being associated with an encoding;
extract signal information from the decoded content data;
process the decoded content data to align with content data from one or more other encodings utilizing the extracted signal information;
process the decoded content data to be interchangeable with the content data from the one or more other encodings utilizing the extracted signal information; and
deliver one or more aligned and interchangeable encodings to a content delivery network (CDN).

16. The non-transitory computer-readable storage medium of claim 15, wherein the executable when executed further instructs a processor to:
implement a filename convention to enable interchangeable playback of the content data from the encoding and the content data from the one or more other encodings.

17. The non-transitory computer-readable storage medium of claim 15, wherein the executable when executed further instructs a processor to:
generate one or more timing markers; and
implement a timing criteria associated with the one or more timing markers.

18. The non-transitory computer-readable storage medium of claim 15, wherein the executable when executed further instructs a processor to:
implement an equivalence calculation to determine a time stamp for aligning the encoding and the one or more other encodings.

19. The non-transitory computer-readable storage medium of claim 15, wherein the equivalence calculation is based on a Society of Motion Picture and Television Engineers (SMPTE) timecode.

20. The non-transitory computer-readable storage medium of claim 15, wherein the executable when executed further instructs a processor to:
implement a first aligner and a second aligner to process the decoded content data to align with content data from the one or more other encodings, wherein the first aligner and the second aligner operate independently of each other.
